(19) United States
(12) Patent Application Publication
(10) Pub. No.: US 2018/0244895 A1
(43) Pub. Date: Aug. 30, 2018

(54) ANTIMICROBIAL AND ANTIVIRAL COMPOSITE POLYMER SURFACES

(71) Applicant: YEDITEPE UNIVERSITESI, ISTANBUL (TR)

(72) Inventors: Zeynep IYIGUNDOGDU, ISTANBUL (TR); Okan DEMIR, ISTANBUL (TR); Fikrettin Sahin, ISTANBUL (TR)

(73) Assignee: YEDITEPE UNIVERSITESI, ISTANBUL (TR)

(21) Appl. No.: 15/755,561

(22) PCT Filed: Aug. 16, 2016
(86) PCT No.: PCT/TR2016/050290

§ 371 Date: Feb. 27, 2018

(30) Foreign Application Priority Data
Sep. 9, 2015 (TR) 2015/11205

(51) Int. Cl. C08K 5/136; A01N 31/16; A01N 47/44; C08K 5/31; C08K 5/00; A01N 55/02; A01N 59/14; C08K 3/38; A01N 25/10

(52) U.S. Cl. CPC C08K 5/136; A01N 31/16; A01N 47/44; C08K 5/31; C08K 5/0091; C08K 2003/387; A01N 59/14; C08K 3/38; A01N 25/10; C08K 2201/018; A01N 55/02

(57) ABSTRACT

The present invention relates to composite polymer surfaces which are endowed with antimicrobial and antiviral properties. In the present invention, polymer composites containing additives are obtained, wherein combinations (comprising at least two or more substances) of boron compounds and/or zinc pyrithione made with chlorhexidine gluconate and/or triclosan are used. The invention enables to prevent biodegradation or biocontamination occurring on surfaces. The invention is for controlling the pathogen factors (bacteria, yeasts, fungi and viruses), which are the causes for surface-borne hygiene, allergy and infectious diseases, in sectors (particularly agriculture, health, food and defense) where polymer composites are widely used.

### CROSS REFERENCE TO RELATED APPLICATIONS

This application is the national phase entry of International Application PCT/TR2016/050290, filed on Aug. 16, 2016, which is based upon and claims priority to Turkish Patent Application No. 2015/11205, filed on Sep. 9, 2015, the entire contents of which are incorporated herein by reference.

### FIELD OF THE INVENTION

The present invention relates to composite polymer surfaces which are endowed with antimicrobial and antiviral properties.

### BACKGROUND OF THE INVENTION

Today, as an alternative to the natural materials whose resources are gradually running out, areas of use of polymers are increasing day by day due to ease in shaping them, their mechanical behaviors, flexible structures, ability to be produced according to purpose of use and their low production costs (Sen, 2010).

While disposable plastic materials are replacing materials such as glass and metal used in medical materials industry; use of polymers, which are easy to prepare and compatible with natural tissues, instead of fragile and hard-to-produce ceramics and rapidly oxidizing metals is becoming widespread. Injectors, gloves, bandages, catheters, implants, lenses, etc. are examples of medical materials. Area of use of polymer materials in medical industry is considerably wide.

However use of these polymers has also brought along many problems. Due to the facts that microorganisms easily cling to the surface of these polymers and that they increase infection risk, use of various additives is required.

Physical and chemical features of materials are the most important factors influencing microorganism colonization on material surfaces. Other than nutrients acquired from materials, humidity rate and penetration inside a material are among the main reasons triggering microbial growth. Therefore, growth of the microorganisms clinging to surfaces depends on a material's humidity absorption and humidity access capacity. Organic and inorganic molecules which can bind on the material and the humidity rate are among the reasons influencing microorganism growth and retention on a surface for a long time. For example, since the polymers used in catheter production vary according to the type and area of use of the catheter, the infection types also vary accordingly. The infections which cause the most mortality and complication risks related to the catheters are the urinary and intravenous infections. According to the studies, while the microorganisms which cause catheter-related bloodstream infections are Staphylococcus epidermidis, Staphylococcus aureus, Candida albicans, Pseudomonas aeruginosa, Klebsiella pneumoniae and Enterococcus faecalis (Abad and Safdar 2011; Hanna et al., 2013); Escherichia coli, Proteus mirabilis and P. aeruginosa are the species which cause the most infections in hemodialysis catheters (Ertek, 1008). Urinary tract and vascular tract are very favorable environments for microorganism growth with respect to the environmental factors such as nutrients, temperature, oxygen rate and pH value. Hence, various materials and methods are developed for antimicrobial catheter production in order to reduce infections occurring at the said areas. In the previous studies, antibacterial property is provided to the polymers by using Minocycline and Rifampicin. However, as these methods are performed via coating method, they are antibacterial only during the production and initial stage of use but do not exhibit antibacterial activity during use.

In addition to medical industry, contaminated microorganisms on or in food products threaten human life while also causing significant financial losses due to food deterioration. Therefore, new packaging materials are required to be developed in order to eliminate food contamination. However, the antimicrobial compounds that will be used in the developed food packaging should not pose any risks to human health. Particularly in meat and dairy products, the bacteria that grow the most are S. aereus, Listeria monocytogenes, Bacillus cereus, E. coli, Salmonella spp. and P. Aeruginosa; the yeast that grows the most is C. albicans and the fungi that grow the most are Penicillium roqueforti and Aspergillus niger (Pitt and Hocking, 2009, Guynot et al., 2003).

Newnham demonstrated in his study that ingestion of 30 mg of borax (Na₂B₄O₇ 10 H₂O) twice daily for three weeks substantially alleviated rheumatism and also Bentwich et al. demonstrated in their study that food products containing boron compounds are useful for human health and that rheumatoid arthritis and osteoarthritis which are very widespread in the world can be treated by consuming boron containing food products (Newnham, 2002, Bentwich et al, 1994). According to Nielsen, humans require a daily amount of 1-3 mg B boron, (Nielsen, 2008). Boron enables to prevent osteoporosis particularly in menopause period of women by influencing steroid hormones (estrogen and testosterone). Similarly, intake of 10 mg B boron daily in men enables to balance these hormones (Lee et al., 1978; Naghii and Samma, 1996, 1997). The concentration level of boron compounds that may be dangerous for humans is determined to be 20 mg per day (Meacham, 2010, National Academy of Sciences Food and Nutrition Board, 2009).

There are studies in the literature on the antimicrobial properties of some boron compounds. Bailey et al. (1980) proved, with the experiments they conducted, that boric acid has antibacterial activity on enteric bacteria. Boron-containing antibacterial agents were tried on gram negative bacteria (E. coli and P. mirabilis) and were observed to be effective (Bailey, 1980).

Upon observation of the effect of boron compounds on microorganisms, it is seen that they reduce enzyme activity of microorganisms and thus cause death of microorganisms (Hunt, 2003). The boron-containing antibiotics called Boromycin and Tartrolon B which were first produced in India have been started to be used for gram-positive bacteria and many fungus type infections (Autian, 2006). According to studies, their antimicrobial property and activity on five bacteria and one fungus species namely E. coli, S. aureus, Streptecocus pyogenes, P. aeruginosa, Bacillus subtilis and C. albicans were tested by disc diffusion method and successful results were achieved (Meacham etc., 2010).

A study by Hennessey (2006) showed that a 10-minute exposure of various bacterial strains to 0.02% chlorhexidine solution lead to 4 log inhibition of these microorganisms (Hennessey, 2006).

A study by Regos et al. indicates that triclosan is 10 to 100 times more effective than hexachlorophene on E. coli, Klebsiella edwardsii and Salmonella spp., but is less effective on streptococci, micrococci, and Propionibacterium acnes. The study also revealed that even low-concentration of triclosan had a broad spectrum activity on both gram-negative and gram-positive bacteria, especially on Proteus vulgaris, Salmonella spp., mycobacteria and anaerobic bacteria (Regos, 1979).

In a study by Bernstein et al (1990), activities of 0.12% chlorhexidine gluconate containing mouthrinse (Peridex) against herpes simplex virus (HSV) related with tooth decay, cytomegalovirus (CMV), influenza A, parainfluenza, polio, and hepatitis B (HBV) virus were researched and the results indicated that it was effective against all the viruses, except polio virus, within 30 seconds (Bernstein, 1990).

A study by Bailey and Longson (1972) indicates that while 0.02% chlorhexidine gluconate reduced the virus titration of Herpesvirus hominis by more than 99% at the end of a 90-minute exposure at room temperature, it remained ineffective against poliovirus and adenovirus (Bailey and Longson, 1972).

Imokawa et al. have stated in their study dated 1982 that zinc pyrithione has antifungal activity against Pityrosporum ovale (Imokawa, 1982).

Furthermore, Reeder et al. have stated in their study dated 2011 that zinc pyrithione has antiyeast activity on Saccharomyces cerevisiae yeast (Reeder, 2011).

Dinning et al., in their study of 1998, determined antibacterial activity of zinc pyrithione on E. coli NCIMB 10000 and P. aeruginosa NCIMB 10548 and specified MIC value as 13 μg ml⁻¹ against P. aeruginosa and 4.5 μg ml⁻¹ against E. coli (Dinning, 1998).

Krenn at al., in their study of 2009, provided that pyrithione and hinokitiol which bind with ions of metals such as zinc inhibited proliferation of humanrhinovirus, coxsackievirus and mengovirus (Krenn, 2009).

### SUMMARY OF THE INVENTION

An objective of the present invention is to provide composite polymer surfaces wherein single or double combinations of boron compounds and zinc pyrithione are used together with chlorhexidine gluconate and/or triclosan.

Another objective of the present invention is to provide antifungal composite polymer surfaces. Another objective of the present invention is to provide anticandidal composite polymer surfaces. Another objective of the present invention is to provide antibacterial composite polymer surfaces. Another objective of the present invention is to provide antiviral composite polymer surfaces. Another objective of the present invention is to provide composite polymer surfaces which prevent biodegradation or biocontamination.

Another objective of the present invention is to provide composite polymer surfaces which are easy to produce and low cost.

A further objective of the present invention is to provide composite polymer surfaces which enables to control pathogen microorganisms and agents causing surface-borne allergic and infectious diseases and to reduce potential diseases.

Another objective of the present invention is to provide long lasting composite polymer surfaces which prevent biocorrosion and biodegradation.

### BRIEF DESCRIPTION OF THE DRAWINGS

“Antimicrobial and antiviral composite polymer surfaces” developed to fulfill the objectives of the present invention are illustrated in the accompanying figures, and the details of these figures are listed below

The abbreviations used in the experimental studies are as follows: Zinc Pyrithione ZP, Triclosan T, Disodium octaborate tetrahydrate DOP, Sodium borate SB.

FIG. 1 is the view of the activity of PVC surfaces containing
1: 2.5% ZP, 10% SB and 0.2% T,
2: 3% ZP and 3% DOT,
3: 3% ZP and 0.2% T,
4: 15% SB, 2% CH against MRSA.

FIG. 2 is the view of the activity of PVC surfaces numbered 1, 2, 3 and 4 against Aspergillus niger.

FIG. 3-a is the view obtained as a result of washing PU surface which is contaminated with Aspergillus niger without any additives and performing regressive isolation via serial dilution method.
b. is the view obtained as a result of washing PU surface which is contaminated with Aspergillus niger containing 3% ZP and 0.2% T, and performing regressive isolation via serial dilution method.

FIG. 4-a is the view obtained as a result of washing PU surface which is contaminated with Candida albicans without any additives and performing regressive isolation via serial dilution method.
b. is the view obtained as a result of washing PU surface which is contaminated with Candida albicans containing 3% ZP and 0.2% T, and performing regressive isolation via serial dilution method.

### DETAILED DESCRIPTION OF THE INVENTION

### Experimental Studies

In the embodiment of the invention, composite polymer surfaces are obtained by mixing boron compounds and zinc pyrithione separately or in combination together with different concentrations and combinations of chlorhexidine gluconate and/or triclosan with polymer granules.

In the present invention; one of zinc borate, sodium borate, sodium perborate tetrahydrate, borax pentahydrate; and preferably disodium octaborate tetrahydrate is selected as the boron compound.

### Antimicrobial Tests

### Modified Disc Diffusion Method

Standard NCCLS disc diffusion method (Lalitha and Vellore, 2005) was used upon being modified in order to determine the antimicrobial activity of boron compounds on each microorganism that is being tested. The 100 μl solution including 10⁸ cfu/ml bacteria, 10⁶ cfu/ml yeast and 10⁴ spore/ml fungi was prepared with new cultures and inoculated with spreading method on Nutrient Agar (NA), Sabouraud Dextrose Agar (SDA) and Potato Dextrose Agar (PDA), respectively. 20 μl of sterile water was dropped on the empty discs and it was separately immersed into pulverized zinc borate, sodium borate, sodium perborate tetrahydrate, borax pentahydrate, disodium octaborate tetrahydrate. The discs coded with zinc borate, sodium borate, sodium perborate tetrahydrate, borax pentahydrate, disodium octaborate tetrahydrate were placed in inoculated petri dishes. Empty discs with 20 μl drop of sterile water were used as negative control. Ofloxacin (10 μg/disc) and nystatin (30 μg/disc) were used as positive control groups for bacteria and fungi, respectively. The petri dishes, which were inoculated and on which modified disc diffusion method was applied, were kept at 36±1° C. for bacteria for 24 hours and for yeasts for 48 hours and at 25±1° C. for fungi for 72 hours. Antimicrobial activity against microorganisms tested with modified disc diffusion method was assessed by measuring the inhibition zone (area where microorganisms do not grow). Antimicrobial activity test results of the tested boron compounds are summarized in Table 1. All tests were repeated at least twice.

### Embodiment 1

For 100 g antimicrobial and antiviral polyvinyl chloride (PVC) composite material; 5 g zinc pyrithione was added from the side powder feeder when 95 g PVC granules were passing through the twin screw extruder at 150° C. and thus PVC composite granules comprising 5% active ingredient were obtained. Then, cold press was applied to PVC composites which were melted at 100-180° C. thereby obtaining antimicrobial and antiviral surfaces. The said obtained surfaces were subjected to antimicrobial activity tests.

### Embodiment 2

For 100 g antimicrobial and antiviral PVC composite material; 5 g zinc pyrithione and 5 g disodium octaborate tetrahydrate were added from the side powder feeder when 90 g PVC granules were passing through the twin screw extruder at 150° C. and thus PVC composite granules comprising 5% active ingredient were obtained. Then, cold press was applied to PVC composites which were melted at 100-180° C. thereby obtaining antimicrobial and antiviral surfaces. The said obtained surfaces were subjected to antimicrobial activity tests.

### Embodiment 3

For 100 g antimicrobial and antiviral polyethylene (PE) composite material; 10 g zinc pyrithione, sodium borate or disodium octaborate tetrahydrate was added from the side powder feeder when 90 g PE granules were passing through the twin screw extruder at 170° C. and thus PE composite granules were obtained. Then, cold press was applied to PE composites, which were melted at 140-180° C., thereby obtaining antimicrobial and antiviral surfaces. The said obtained surfaces were subjected to antimicrobial activity tests.

### Embodiment 4

For 100 g antimicrobial and antiviral polyethylene (PE) composite material; 10 g disodium octaborate tetrahydrate, 5 g zinc pyrithione and 0.2 g triclosan were added from the side powder feeder when 84.8 g PE granules were passing through the twin screw extruder at 170° C. and thus PE composite granules were obtained. Then, cold press was applied to PE composites, which were melted at 140-180° C., thereby obtaining antimicrobial and antiviral surfaces. The said obtained surfaces were subjected to antimicrobial activity tests.

### Embodiment 5

For 100 g antimicrobial and antiviral polyurethane (PU) composite material; 3 g sodium borate and 0.26 g zinc pyrithione were added from the side powder feeder when 96.74 g PU granules were passing through the twin screw extruder at 170° C. and thus PU composite granules were obtained. Then, cold press was applied to PU composites which were melted at 170-220° C. thereby obtaining antimicrobial and antiviral surfaces. The said obtained surfaces were subjected to antimicrobial activity tests.
In application of the invention; preferably PVC, PE, PP and PU polymers were selected; additionally Polyamide (PA), Polystyrene (PS), Polyethylene terephthalate (PET), Polycarbonate (PC), Polymethylmethacrylate (PMMA), Polydimethylsiloxane (PDMS), Polyoxymethylene (POM), Polytetrafloroethylene (PTFE), Polyether ketone (PEEK), Acrylonitrile Butadiene Styrene (ABS), Thermoplastic Elastomer (TPE), Styrene Acrylonitrile (SAN), Polylactide (PLA) polymers can also be used.
Zinc borate, sodium borate, sodium perborate tetrahydrate, borax pentahydrate and disodium octaborate tetrahydrate were preferred among the boron compounds each at ratios of (1-20%).
Antimicrobial and antiviral polymer composites can be obtained by mixing zinc pyrithione (1-20%) and triclosan (0.001-0.2%) at different combinations.

Antimicrobial activity tests of sections of the developed polymer composite surfaces prepared at sizes of 5×5 cm and 1×1 cm were performed via the below mentioned methods.

### Antimicrobial Activity Tests of the Prepared Polymer Composite Surfaces;

Antimicrobial activity tests for antimicrobial and antiviral composite surfaces were performed simultaneously using two different methods.

In the first test method; isolates from the bacteria Escherichia coli, Staphylococcus aureus, Pseudomonas aeruginosa; the yeasts Candida albicans and Candida glabrata and the fungi Aspergillus niger, Botrytis cinerea, Fusarium oxysporum, Penicillium vinaceum, Penicillium expansum were inoculated on petri dishes containing suitable media (NA, SDA and PDA respectively). Polymer surfaces prepared at sizes of 1×1 cm were placed on the inoculated petri dishes. The inoculated petri dishes were incubated for 24 hours for bacteria and 48 hours for yeasts at 36±1° C. and 72 hours for fungi at 25±1° C. Antimicrobial activities of the polymer composite surfaces were assessed by the inhibition zone (area where microorganisms do not grow) formed around them.

In the second method, 1 ml medium was poured on polymer composite surfaces of 5×5 cm placed on empty petri dishes. The media placed on the surfaces were contaminated by 100 μl of the solutions (containing 10⁸ cfu/ml bacteria, 10⁶ cfu/ml yeast and 10³ spore/ml fungi) prepared from the fresh media within the buffer solution, and sterilized plastic films of 4×4 cm were placed thereon such that the media was prevented from overflowing. The contaminated polymer surfaces were incubated for 24 hours for bacteria and 48 hours for yeasts at 36±1° C. and 72 hours for fungi at 25±1° C. The tested polymer surfaces were washed with 10 ml PBS solution and upon performing regressive isolation via serial dilution method it was determined whether there was microbial growth thereon.

Experimental studies were carried out with certain fungus, yeast and bacteria species. Among these microorganisms, the bacteria were Escherichia coli, Staphylococcus aureus, and Pseudomonas aeruginosa, MRSA and VRE.

The yeasts used in the experimental studies were Candida albicans and Candida glabrata and the fungi used in the same were Fusarium oxysporum, Botrytis cinerea and Aspergillus niger.

### Antiviral Tests

### Antiviral Activity Tests of Chlorhexidine Gluconate and Zinc Pyrithione;

In order to produce Human adenovirus type 5 Adenoid 75 strain and poliovirus type 1 Chat strain virus and to carry out the experiment, a complete layer of HEp-2 cells (ATCC CCL-23), which are human monolayer tumor cells, were used. For determining virus titration, reference Human adenovirus type 5 Adenoid 75 strain and poliovirus type 1 Chat strain were inoculated by making serial dilutions to HEp-2 cells, and by taking as basis the virus dilution that produces a cytopathic effect visible in invert microscope, virus titration was computed by using Spearman-Karber method. In order to determine Sub-Cytotoxic concentration of Chlorhexidine gluconate and Zinc pyrithione, Chlorhexidine gluconate and zinc pyrithione were 10-fold serially diluted with Eagle's minimum essential medium (MEM) and their non-toxic concentrations in the cell medium were determined and these concentrations were used in the experiments. For the controls, MEM inoculated HEp-2 cells, full layer HEp-2 cells wherein Chlorhexidine gluconate and zinc pyrithione was not added, 10-fold diluted reference virus titration control, formaldehyde control and controls containing toxic concentrations of Chlorhexidine gluconate and zinc pyrithione were used as negative control instead of the virus.

### Preparation of Cell Culture Medium and the Chemicals

MEM medium: 10% serum (FBS) containing enzymes, hormones and growth factors for the cells to be able to cling to the surfaces and proliferate; and 40 IU/ml penicillin, 0.04 mg/ml streptomycin, 0.5 mg/ml glutamine to prevent fungi and bacteria contamination; and 1% Sodium Bicarbonate as a buffer solution were added therein.

FBS: Inactivated and mycoplasma-free
Sodium bicarbonate: Sterile 7.5% solution
Medium Used in Virus Inoculation: The medium included 1% antibiotic (Penicillin, Streptomycine, Amphotericin B) in order to prevent fungi and bacteria contamination, and 1% Sodium bicarbonate as a buffer solution. FBS serum was not added to this medium.

### Preparation of Clean and Contaminated Media:

Clean medium; 0.3 gr Bovine Serum Albumin Fraction V was dissolved in 100 ml sterile water. The solution that was obtained was sterilized by being passed through a filter with mesh size 0.22 μM.

Contaminated medium; Sheep Erythrocyte and BSA were used for the contaminated medium. 3 g BSA was dissolved in 100 ml sterile water and filtered. 3 ml sheep erythrocyte was completed to 97 ml BSA.

Erythrocyte; 8 ml fresh sheep blood was rotated at 800 G for 10 minutes and then its supernatant was removed. Upon adding 8 ml phosphate buffer salt (PBS) thereon, pipetting was performed and it was again rotated at 800 G for 10 minutes. This procedure was repeated three times.

### Analysis:

Firstly, liquid Chlorhexidine gluconate and zinc pyrithione was solid serially diluted with the cell culture medium (MEM) and its non-toxic concentration in cell culture was calculated. 8 ml of the Chlorhexidine gluconate and zinc pyrithione that was to be tested was mixed with 2 ml hard water. The obtained solution was serially diluted (dilution step 1:10) with MEM. It was inoculated in 96-well monolayered cells. The microscopic changes that occurred were recorded. Concentrations that showed cytopathic effect (CPE) were determined. Chlorhexidine gluconate, zinc pyrithione and formaldehyde CPE values were compared. After determining non-toxic concentration of chlorhexidine gluconate and zinc pyrithione on the cells, the effects of chlorhexidine gluconate and zinc pyrithione on virus titration as a result of 5-60 minutes application periods in clean and contaminated media were separately studied. For the controls, MEM inoculated HEp-2 cells, full layer HEp-2 cells wherein Chlorhexidine gluconate and zinc pyrithione was not added, 10-fold diluted reference virus titration control, formaldehyde control and controls containing toxic concentrations of Chlorhexidine gluconate and zinc pyrithione were used as negative control instead of the virus.

Taking as basis the virus dilutions wherein cytopathic effect that is visible in invert microscope is formed, virus titration was calculated as TCID₅₀ value by using Spearman-Karber method. According to TS EN 14476 (MARCH 2007) standard, disinfectants should reduce virus titration by 4 or more logs for their antiviral activities.

### Experimental Results

### Antimicrobial Test Results:

Antimicrobial activity test results of the tested boron compounds are summarized in Table 1. All tests were repeated at least twice.

TABLE 1
Antimicrobial activity of Zinc borate (ZB), Sodium Borate (SB),
Sodium perborate tetrahydrate (SPT), Borax pentahydrate
(BP) and Disodium octaborate tetrahydrate (DOT) on the
tested microorganisms

| | Boron compounds | | | | |
|---|---|---|---|---|---|
| Mikroorganisms | ZB | SB | SPT | BP | DOT |
| BAKTERIA | | | | | |
| Vancomycin-resistant | + | + | + | + | + |
| Enterococcus (VRE) | | | | | |
| Methicillin-resistant Staphylococcus | + | + | + | + | + |
| aureus (MRSA) | | | | | |
| Escherichia coli | + | + | + | + | + |
| Staphylococcus aureus | + | + | + | + | + |
| Pseudomonas aeruginosa | + | + | + | + | + |
| YEASTS | | | | | |
| Candida albicans | + | + | + | + | + |
| Candida glabrata | + | + | + | + | + |
| FUNGI | | | | | |
| Aspergillus spp. | + | + | + | + | + |
| Fusarium oxysporum | + | + | + | + | + |
| Botrytis cinerea | + | + | + | + | + |
| Penicillium spp. | + | + | + | + | + |

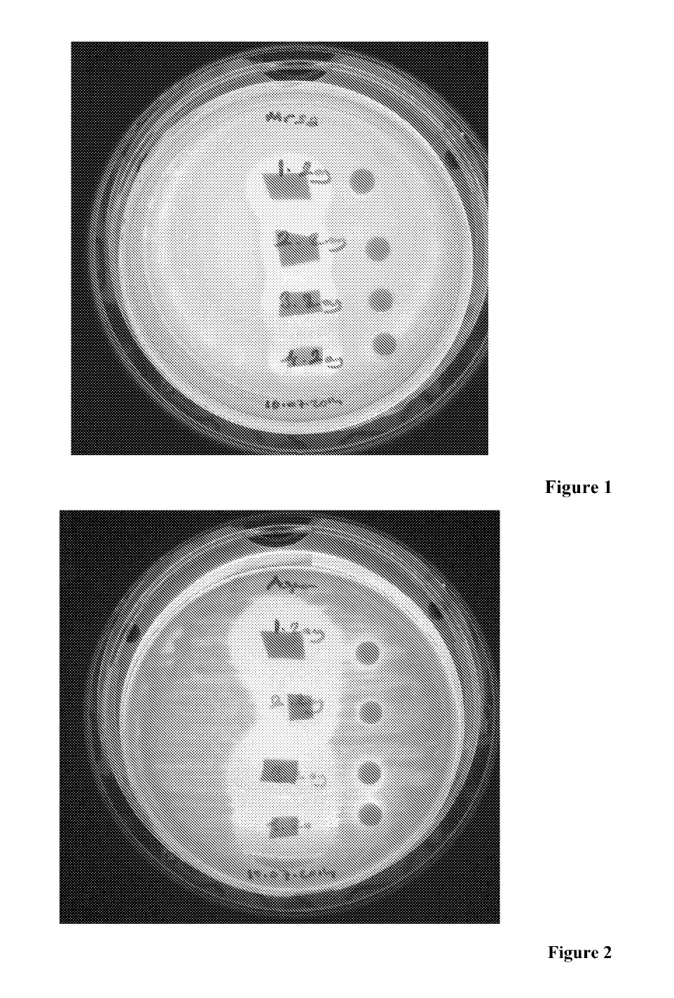

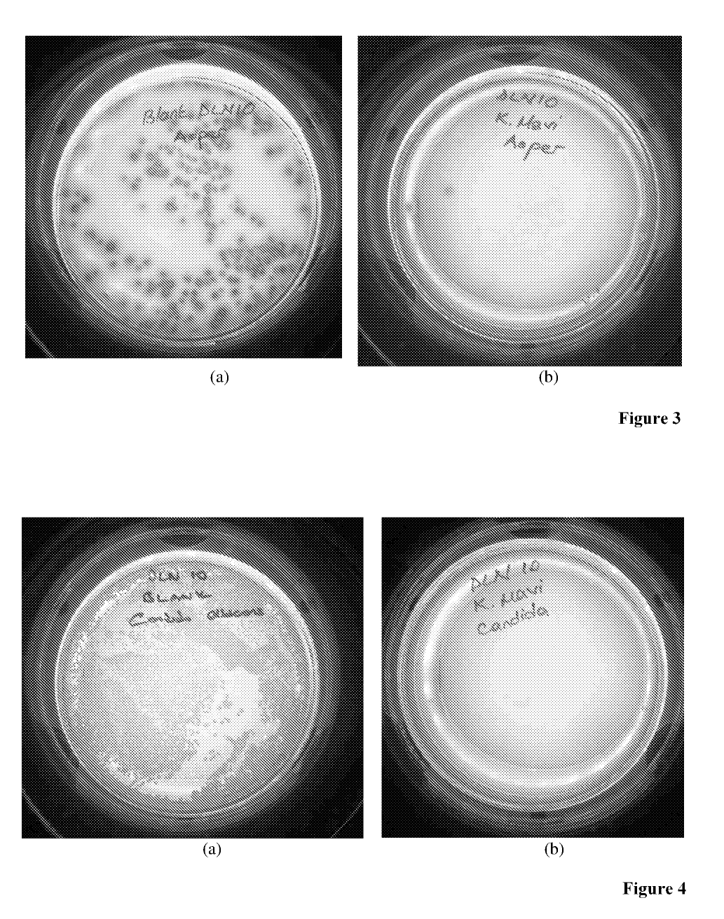

Antimicrobial activities of the prepared products were tested by using bacteria (Escherichia coli, Staphylococcus aureus, Pseudomonas aeruginosa, MRSA and VRE), yeast (Candida albicans and Candida glabrata) and fungus (Fusarium oxysporum, Botrytis cinerea, Aspergillus niger, Penicillium vinaceum, Penicillium expansum Aspergillus niger, Botrytis cinerea, Fusarium oxysporu and Penicillium spp.) isolates. According to the obtained results; it was observed that polymer surfaces containing boron compounds, zinc pyrithione, triclosan and chlorhexidine gluconate had antimicrobial activity on all of the tested microorganisms. Developed antimicrobial activity test results are summarized in Table-2. Example images related to the antimicrobial activity test results are given in FIG. 1-4.

TABLE 2
Antimicrobial activity of the polymers containing Zinc borate (ZB), Sodium Borate
(SB), Disodium octaborate tetrahydrate (DOT), Triclosan (T), Chlorhexidine gluconate (CH) and
combinations thereof on the tested microorganisms

| | POLYMERS | | | | | | | | | | | | | | | | |
|---|---|---|---|---|---|---|---|---|---|---|---|---|---|---|---|---|---|
| | PVC | | | | PE | | | | PU | | | | PP | | | | |
| | Combinations | | | | | | | | | | | | | | | | |
| Microorganisms | 1 | 2 | 3 | 4 | 5 | 6 | 7 | 8 | 9 | 10 | 11 | 12 | 13 | 14 | 15 | 16 | NC |
| BACTERIA | | | | | | | | | | | | | | | | | |
| Escherichia coli | +^{a} | + | + | + | + | + | + | + | + | + | + | + | + | + | + | + | −^{b} |
| Staphylococcus aureus | + | + | + | + | + | + | + | + | + | + | + | + | + | + | + | + | − |
| Pseudomonas aeruginosa | + | + | + | + | + | + | + | + | + | + | + | + | + | + | + | + | − |
| MRSA | + | + | + | + | + | + | + | + | + | + | + | + | + | + | + | + | − |
| VRE | + | + | + | + | + | + | + | + | + | + | + | + | + | + | + | + | − |
| YEASTS | | | | | | | | | | | | | | | | | |
| Candida albicans | + | + | + | + | + | + | + | + | + | + | + | + | + | + | + | + | − |
| Candida glabrata | + | + | + | + | + | + | + | + | + | + | + | + | + | + | + | + | − |
| FUNGI | | | | | | | | | | | | | | | | | |
| Aspergillus niger | + | + | + | + | + | + | + | + | + | + | + | + | + | + | + | + | − |
| Botrytis cinerea | + | + | + | + | + | + | + | + | + | + | + | + | + | + | + | + | − |
| Fusarium oxysporum | + | + | + | + | + | + | + | + | + | + | + | + | + | + | + | + | − |
| Penicillium spp. | + | + | + | + | + | + | + | + | + | + | + | + | + | + | + | + | − |

^{a}+ sign indicates that the boron compounds had antimicrobial activity.
^{b}− sign indicates that there is no antimicrobial activity.
1: PVC containing 2.5% ZP, 10% SB and 0.2% T
2: PVC containing 3% ZP and 3% DOT
3: PVC containing 3% ZP and 0.2% T
4: PVC containing 15% SB and 2% CH
5: PE containing 2 5% ZP, 10% SB and 0.2% T
6: PE containing 3% ZP and 3% DOT
7: PE containing 3% ZP and 0.2% T
8: PE containing 15% SB and 2% CH
9: PU containing 2.5% ZP, 10% SB and 0.2% T
10: PU containing 3% ZP and 3% DOT
11. PU containing 3% ZP and 0.2% T
12: PU containing 15% SB and 2% CH
13: PP containing 2 5% ZP, 10% SB and 0.2% T
14: PP containing 3% ZP and 3% DOT
15: PP containing 3% ZP and 0.2% T
16: PP containing 15% NaB and 2% CH
NC: Negative control;
PVC, PE, PU, PP not containing any additives

### Antiviral Tests:

It was observed in the calculations made as a result of the test that chlorhexidine gluconate caused at least 4 log reduction in virus titer at all experiment conditions (Table 53 and Table 4) as a result of application at a ratio of 1/1, at room temperature (20° C.), in clean and contaminated media and with 1 and 60 minute application periods. According to Antimicrobial Division US EPA standards, disinfectants should reduce virus titer by 4 or more logs for their virucidal activities.

TABLE 3
Antiviral activity of chlorhexidine gluconate in Hep-2 cell culture
against Human adenovirus type 5 virus Adenoid 75 strain

| | | Chlorhexidine Gluconate | | | |
|---|---|---|---|---|---|
| | Reference virus | 1 minute | | 60 minutes | |
| Virus titer* | 5.5 | Clean | Contamin. | Clean | Contamin. |
| | | medium | medium | medium | medium |

| | | | | |
|---|---|---|---|---|
| Virus titer with disinfectant** | 1.5 | 1.5 | 1.5 | 1.5 |
| Reduction ratio in virus | 4.0 | 4.0 | 4.0 | 4.0 |
| titer*** | | | | |

*Logarithmic TCID₅₀ value of the virus in ml.
**Logarithmic TCID₅₀ value of the virus treated with the disinfectant at different periods and media.
***Logarithmic TCID50 ratio between the virus titer and the virus titer with disinfectant

TABLE 4
Antiviral activity of chlorhexidine gluconate in HEp-2 cell
culture against poliovirus type 1 virus Chat strain

| | | Chlorhexidine Gluconate | | | |
|---|---|---|---|---|---|
| | Reference virus | 1 minute | | 60 minutes | |
| Virus titer* | 6.0 | Clean | Contamin. | Clean | Contamin. |
| | | medium | medium | medium | medium |

| | | | | |
|---|---|---|---|---|
| Virus titer with disinfectant** | 2.0 | 2.0 | 2.0 | 2.0 |
| Reduction ratio in virus | 4.0 | 4.0 | 4.0 | 4.0 |
| titer*** | | | | |

*Logarithmic TCID₅₀ value of the virus in ml.
**Logarithmic TCID₅₀ value of the virus treated with the disinfectant at different periods and media.
***Logarithmic TCID₅₀ ratio between the virus titer and the virus titer with disinfectant

It was observed in the calculations made as a result of the test that zinc pyrithione caused at least 4 log reduction in virus titer at all experiment conditions (Table 5 and Table 6) as a result of application at a ratio of 1/1, at room temperature (20° C.), in clean and contaminated media and with 1 and 60 minute application periods. According to Antimicrobial Division US EPA standards, disinfectants should reduce virus titer by 4 or more logs for their virucidal activities.

TABLE 5
Antiviral activity of zinc pyrithione in HEp-2 cell culture
against Human adenovirus type 5 virus Adenoid 75 strain

| | | Zinc pyrithione | | | |
|---|---|---|---|---|---|
| | Reference virus | 1 minute | | 60 minutes | |
| Virus titer* | 5.0 | Clean | Contamin. | Clean | Contamin. |
| | | medium | medium | medium | medium |

| | | | | |
|---|---|---|---|---|
| Virus titer with disinfectant** | 1.0 | 1.0 | 1.0 | 1.0 |
| Reduction ratio in virus | 4.0 | 4.0 | 4.0 | 4.0 |
| titer*** | | | | |

*Logarithmic TCID₅₀ value of the virus in ml.
**Logarithmic TCID₅₀ value of the virus treated with the disinfectant at different periods and media.
***Logarithmic TCID₅₀ ratio between the virus titer and the virus titer with disinfectant

TABLE 6
Antiviral activity of zinc pyrithione in Hep-2 cell culture
against poliovirus type 1 virus Chat strain

| | | Zinc pyrithione | | | |
|---|---|---|---|---|---|
| | Reference virus | 1 minute | | 60 minutes | |
| Virus titer* | 5.5 | Clean | Contamin. | Clean | Contamin. |
| | | medium | medium | medium | medium |

| | | | | |
|---|---|---|---|---|
| Virus titer with disinfectant** | 1.5 | 1.0 | 1.5 | 1.5 |
| Reduction ratio in virus | 4.0 | 4.5 | 4.0 | 4.0 |
| titer*** | | | | |

*Logarithmic TCID₅₀ value of the virus in ml.
**Logarithmic TCID₅₀ value of the virus treated with the disinfectant at different periods and media.
***Logarithmic TCID50 ratio between the virus titer and the virus titer with disinfectant

As a conclusion; these experiment results show that chlorhexidine gluconate and zinc pyrithione is 99.9% active against Human adenovirus type 5 virus and 99.9% active against poliovirus type 1 virus when used directly without being diluted at room temperature (20° C.) within 1 and 60 minute application periods.

The composite polymers of the present invention are used in the medical industry which is required to be antimicrobial. The said composites do not cause any toxic or irritant effect on human body.

The present invention can be used in all kinds of polymeric surfaces. Antimicrobial and antiviral surfaces will be developed in a very broad spectrum to be used in textile, electronic goods, automotive industry, medical sector, construction materials, agriculture, biomedical science, packaging, hygiene, food, industrial design, sports goods, energy industry, defense industry, and in all sectors wherein antimicrobial and antiviral activities are desired and biodegradation is desired to be controlled.

What is claimed is:

1-9. (canceled)

10. A composite polymer surface comprising: zinc pyrithione, boron compound and polymer granules.

11. The composite polymer surface of claim 10 further comprises triclosan.

12. The composite polymer surface of claim 11, wherein the boron compound is sodium borate.

13. The composite polymer surface of claim 12, wherein the mass ratio of zinc pyrithione is 2.5%, the mass ratio of sodium borate is 10%, and the mass ratio of triclosan is 0.2%.

14. The composite polymer surface of claim 10, wherein the boron compound is disodium octaborate tetrahydrate.

15. The composite polymer surface of claim 14, wherein the mass ratio of zinc pyrithione is 3%, and the mass ratio of disodium octaborate tetrahydrate is 3%.

16. A composite polymer surface comprising sodium borate, chlorhexidine gluconate and polymer granules.

17. The composite polymer surface of claim 16, wherein the mass ratio of sodium borate is 15% and the mass ratio of chlorhexidine gluconate is 2%.

18. A composite polymer surface comprising zinc pyrithione, triclosan and polymer granules.

19. The composite polymer surface of claim 18, wherein the mass ratio of zinc pyrithione is 3% and the mass ratio of by mass of triclosan is 0.2%.

20. The composite polymer surface of claim 10, wherein the polymer granules are made of one or more materials selected from the group consisting of polypropylene, polyester, polystyrene, polyamide, polyoxymethylene, polyethylene terephthalate, polycarbonate, polymethylmethacrylate, polydimethylsiloxane, polytetrafloroethylene, polyether ketone, acrylonitrile butadiene styrene, thermoplastic elastomer, styrene acrylonitrile, polylaktide, polyvinylchloride, polypropylene, polyethylene and polyurethane.

21. The composite polymer surface of claim 16, wherein the polymer granules are made of one or more materials selected from the group consisting of polypropylene, polyester, polystyrene, polyamide, polyoxymethylene, polyethylene terephthalate, polycarbonate, polymethylmethacrylate, polydimethylsiloxane, polytetrafloroethylene, polyether ketone, acrylonitrile butadiene styrene, thermoplastic elastomer, styrene acrylonitrile, polylaktide, polyvinylchloride, polypropylene, polyethylene and polyurethane.

22. The composite polymer surface of claim 18, wherein the polymer granules are made of one or more materials selected from the group consisting of polypropylene, polyester, polystyrene, polyamide, polyoxymethylene, polyethylene terephthalate, polycarbonate, polymethylmethacrylate, polydimethylsiloxane, polytetrafloroethylene, polyether ketone, acrylonitrile butadiene styrene, thermoplastic elastomer, styrene acrylonitrile, polylaktide, polyvinylchloride, polypropylene, polyethylene and polyurethane.
